(19) United States
(12) Patent Application Publication
(10) Pub. No.: US 2004/0070267 A1
(43) Pub. Date: Apr. 15, 2004

(54) Subassembly equipped with a motor

(76) Inventors: Peter Volz, Darmstadt (DE); Erhard Beck, Weilburg (DE)

Correspondence Address: RatnerPrestia, One Westlakes Berwyn Suite 301, PO Box 980, Valley Forge, PA, 19482-0980, US

(21) Appl. No.: 10/450,015

(22) PCT Filed: Dec. 12, 2001
(86) PCT No.: PCT/EP01/14586

(30) Foreign Application Priority Data
Dec. 21, 2000 (DE) 100 61 905.3

(51) Int. Cl. B60T 8/40

(52) U.S. Cl. 303/116.4

(57) ABSTRACT

The present invention relates to a subassembly (1)), in particular a brake unit of an electronically controlled vehicle brake system, including a motor (2) having a housing (7), a hydraulic block (4), and a motor electronics (6) for controlling or regulating the motor (2). To create a particularly compact subassembly that is optimized in terms of heat dissipation, the motor electronics (6) is located at least partly within the housing (7) of the motor (2) according to the invention.

The present invention relates to a subassembly, in particular a brake unit of an electronically controlled vehicle brake system, including a motor having a housing, a hydraulic block, and a motor electronics for controlling or regulating the motor.

A subassembly of this type is e.g. disclosed in German published application DE 43 20 005 A1. Especially in the field of motor vehicle brakes, there is a majority of brake units where a pump arranged in a hydraulic block is driven by means of an electric motor. The motor and, hence, the pump is controlled or regulated by means of a motor electronics which is typically mounted in a controller housing on a side of the hydraulic block opposite the motor.

Electronically controlled motor vehicle brakes are currently employed not only for initiating a braking operation such as in ABS or TCS (traction slip control) but also for controlling the driving dynamics as in the electronic stability program ESP, for example. In this respect, an increasingly sophisticated electronic unit is required for controlling and regulating the motors. This necessitates, on the one hand, a larger mounting space on the main printed circuit board in the controller housing, and causes heat problems, on the other hand, because the motor control in particular concerns power electronics with a high degree of heat dissipation.

In view of the above, an object of the present invention is to provide a subassembly with a motor that complies with such up-to-date requirements. In particular, the subassembly is desired to have a small size and a design optimized in terms of heat dissipation.

This object is achieved in a generic subassembly with a motor in that the motor electronics is located at least partly within the housing of the motor. Thus, the invention arranges for the motor electronics to be shifted from the previously customary controller housing into the motor housing wherein there is rather mounting space available that is needed for the motor electronics. Advantageously, this disintegrated type of construction permits diminishing the size of the controller housing. Besides, this arrangement offers special advantages with respect to the heat dissipation of the motor electronics.

According to a particularly preferred embodiment, the motor electronics is incorporated at a side of the motor close to the hydraulic block. This offers especially the possibility of conducting the dissipation heat of the electronics directly into the hydraulic block. For this purpose, the hydraulic block is preferably made of a heat-conductive material, in particular of aluminum. Alternatively, the motor electronics may also be arranged on the side of the motor remote from the hydraulic block, if there is no other possibility for space reasons.

Preferably, the motor electronics is arranged at a separate component, which may e.g. be a board and, more particularly, an end plate of the motor. An end plate of this type separates the motor from the hydraulic block and may also be used to accommodate a bearing for the mounting support of the motor shaft.

It is especially advantageous that the motor electronics is arranged on the board together with other electronic components, and the board in turn is provided on the end plate or connected thereto. In particular, one or more rotational sensors for monitoring the motor rotational speed may be arranged on the board.

A major advantage of the present invention is achieved when a heat coupling means is interposed between the motor and the hydraulic block. The heat coupling means is preferably connected directly to the motor electronics and/or the board so that the dissipation heat of the electronics can be discharged into the hydraulic block. It is advisable for the optimal heat dissipation that the heat coupling means bears directly against the block in the assembled condition of motor and hydraulic block. To this end, the heat coupling means could also be integrally designed with the hydraulic block.

For example, a modular design of components of subassemblies with different motors may be easily realized with the arrangement of the motor electronics of the invention. In a basic variant with reduced power, an auxiliary electronics e.g. arranged in the controller housing will directly take over motor control. At an increased power requirement, a motor with an integrated motor electronics according to the invention may then be used, thereby obviating the need to modify the other subassemblies. Depending on the power and/or comfort requirements, a conventional direct-current motor (with brushes) as well as a brushless motor can be used to this effect.

The present invention and further features, objectives, advantages and possible applications of the invention will be explained in detail in the following by making reference to the accompanying drawings. In the drawings, like reference numerals designate like or corresponding elements. All elements described and/or illustrated in the Figures per se or in any optional suitable combination represent the subject subject matter of the present invention, irrespective of their combination in the claims of their appendencies.

In the drawings,

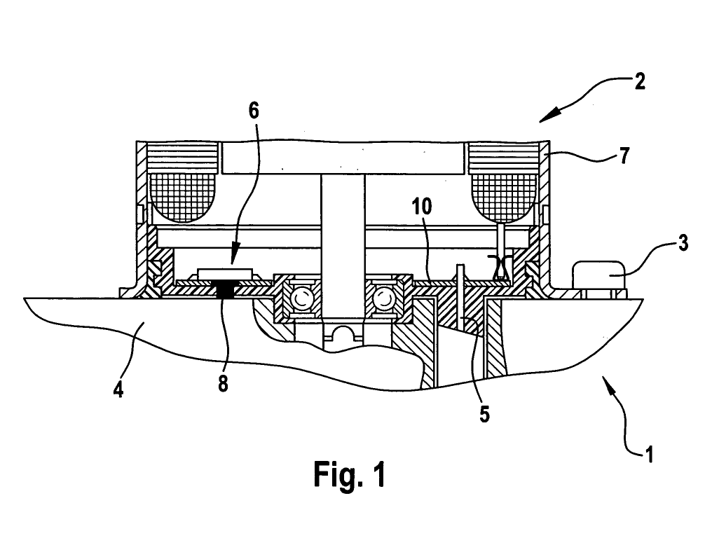

FIG. 1 is a partial cross-sectional view of a segment of the subassembly with a motor of the invention.

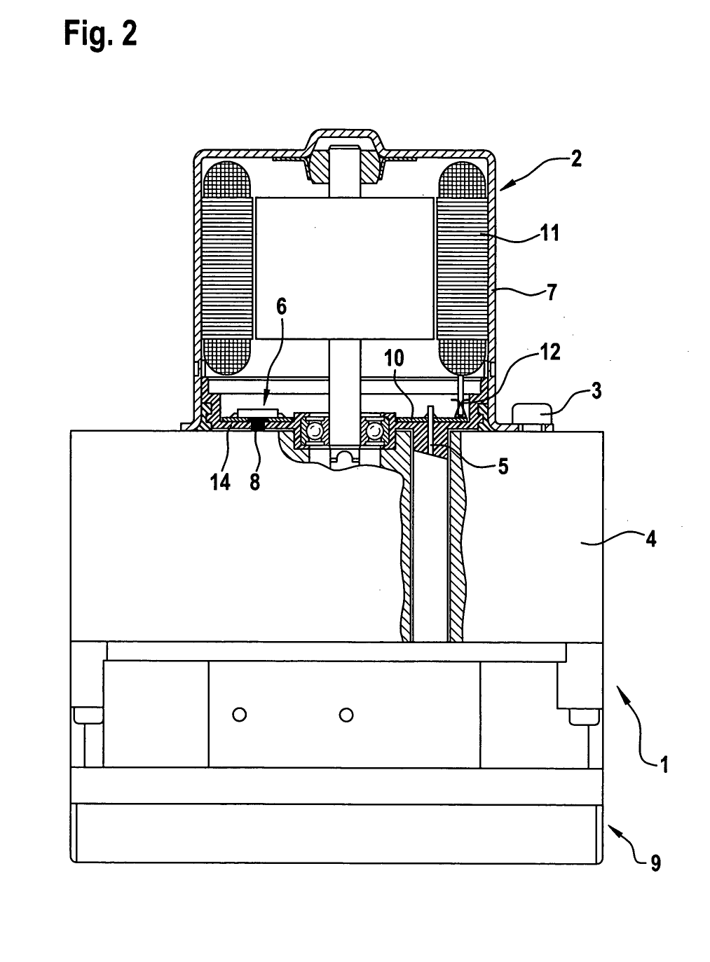

FIG. 2 is a side view of the subassembly with a cross-sectional view of the motor in a first embodiment.

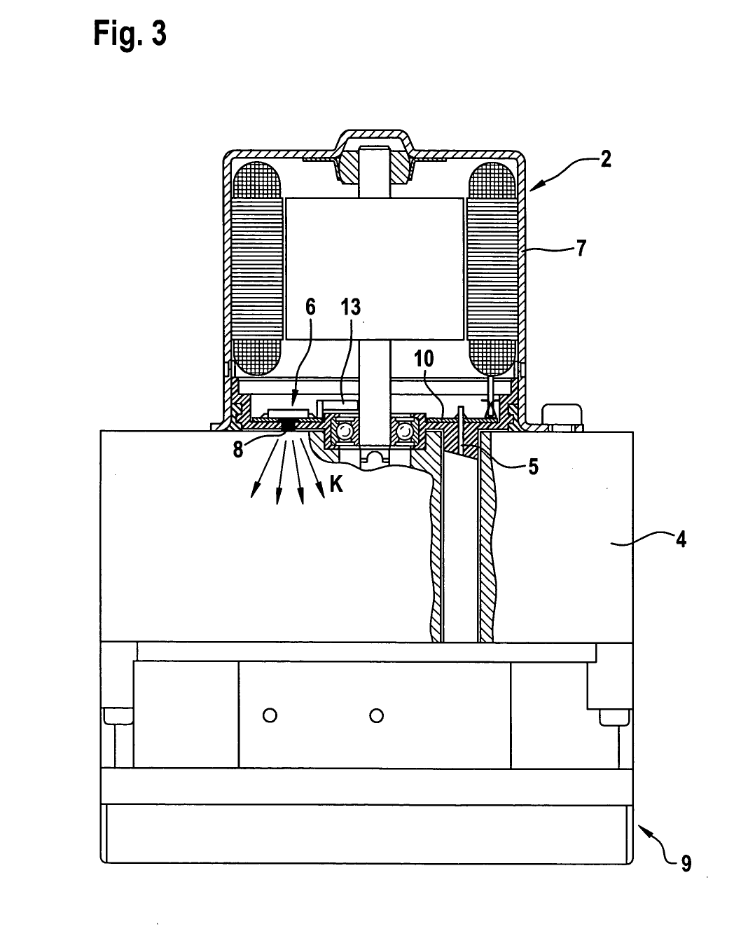

FIG. 3 is a second embodiment of a subassembly with a motor according to the present invention.

FIG. 1 depicts in a partial cross-sectional view the subassembly 1 of the invention, which may e.g. be a brake unit of an electronically controlled vehicle brake, with a motor 2. Motor 2 is secured to a hydraulic block 4, by way of a coupling means 3, e.g. a screw. The energy supply of motor 2 or of said's control e.g. takes place by way of a plug connection 5 that is connected to other electronic components in an electrically conductive fashion. Said components may be arranged in a controller housing not shown.

A motor electronics 6 is arranged at least partly within a housing 7 of motor 2 according to the invention. Thus, the motor electronics 6 is shifted from the so far customary controller housing (not shown) at least partly into the housing 7, wherein the mounting space required for the motor electronics 6 is more likely available.

Preferably, the motor electronics 6 is provided at a side of the motor 2 close to the hydraulic block 4. In particular, this renders it possible to dissipate the dissipation heat of the electronics 6 directly into the hydraulic block 4. However, the electronics may also be arranged on the other side of the motor 2, meaning the side (not shown) remote from the hydraulic block 4, if this is necessary for reasons of space.

Further, the arrangement of the motor electronics 6 of the invention offers special advantages in terms of the discharge of the dissipation heat of the electronics 6, especially if the power electronics develops major heat. It is especially favorable to provide a heat coupling means 8 directly at the motor electronics 6 and/or a board 10 for dissipating the heat into the hydraulic block 4. Due to the special thermal conductivity features it is particularly advantageous that the hydraulic block 4 is made of aluminum. Also with any other material, however, said block should exhibit a good thermal conductivity.

FIG. 2 shows a view of the complete subassembly 2 of the invention that has already been described in FIG. 1, for what reason the above description is referred to. In addition, a controller housing 9 is illustrated at the end of the hydraulic block 4 opposite the motor 2. This controller housing 9 may e.g. house the electronics for controlling a vehicle brake system.

Preferably, the motor electronics 6 is mounted at a separate component, which may e.g. be the board 10 and, more particularly, an end plate 14 of motor 2. An end plate 14 of this type separates the motor 2 from the hydraulic block 4 and may also be used to accommodate a non-illustrated bearing for the mounting support of a motor shaft (likewise not shown).

In a particularly favorable manner the motor electronics 6 is arranged on the board 10 jointly with other electronic components, and the board 10 in turn may be provided on the end plate 14. Board 10 may also be connected to end plate 14, for example, the end plate 14 may even carry the board 10.

The current supply of a winding 11 is provided in this embodiment by way of the plug coupling 5, the board 10, and terminals 12. As shown herein, the motor 2 may be configured as a brushless motor 2 having an increased power requirement so that the present invention is particularly apt for implementation on a like motor 2.

FIG. 3 shows an alternative embodiment of the invention compared to FIG. 2. As the components are basically equal, however, reference is made to the above descriptions. In FIG. 3, a rotational speed sensor 13 is additionally arranged on board 10, this location being especially suited for the sensor in terms of mounting space and electrical connection. It is further illustrated how thermal radiation K of the motor electronics 6 especially designed as power electronics is dissipated into the hydraulic block 4 by way of the heat coupling means 8. The connection 5 of board 10 to the controller housing 9 e.g. comprises at least two lines for the energy supply and one line for a controlling or regulating signal for motor 2.

The arrangement of the motor electronics 6 according to the invention, for example, allows easily realizing a modular design of components of subassemblies 1 with different motors 2. In a basic variant with reduced power, for example, an auxiliary electronics incorporated in the controller housing 9 will directly assume the motor control. With an increased power requirement a motor 2 with an integrated motor electronics 6 according to the invention may be used so that there is no need to modify the other subassemblies.

1. Subassembly (1), in particular brake unit of an electronically controlled vehicle brake system, including a motor (2) having a housing (7), a hydraulic block (4), and a motor electronics (6) for controlling or regulating the motor (2),
characterized in that the motor electronics (6) is located at least partly within the housing (7) of the motor (2).

2. Subassembly (1) as claimed in claim 1,
characterized in that the motor electronics (6) is incorporated at a side of the motor (2) close to the hydraulic block (4).

3. Subassembly (1) as claimed in claim 1 or 2,
characterized in that the motor electronics (6) is arranged at a separate component (10, 14) which is interposed between the motor (2) and the hydraulic block (4).

4. Subassembly (1) as claimed in claim 3,
characterized in that the motor electronics (6) is arranged on a board (10) provided at an end plate (14) of the motor (2).

5. Subassembly (1) as claimed in any one of claims 1 to 4,
characterized in that at least one rotational speed sensor (13) is mounted in adjacency to the motor electronics (6), preferably, on the board (10).

6. Subassembly (1) as claimed in any one of the preceding claims,
characterized in that a heat coupling means (8) is interposed between the motor (2) and the hydraulic block (4), said heat coupling means being connected in particular directly to the motor electronics (6) and/or the board (10).

7. Subassembly (1) as claimed in claim 6,
characterized in that the hydraulic block (4) is made of any heat-conductive material, in particular aluminum.

8. Subassembly (1) as claimed in claim 1,
characterized in that the motor electronics (6) is provided at a side of the motor (2) remote from the hydraulic block (4).
